(19) United States
(12) Patent Application Publication
(10) Pub. No.: US 2021/0104393 A1
(43) Pub. Date: Apr. 8, 2021

(54) SYSTEMS AND METHODS FOR IONIZING A SURFACE

(71) Applicant: 1st Detect Corporation, Webster, TX (US)

(72) Inventors: Jan HENDRIKSE, Whitby (CA); John Daniel DEBORD, Houston, TX (US); Stephen DAVILA, Pearland, TX (US); Offie Lee DRENNAN, League City, TX (US); Michael TEETER, Webster, TX (US)

(21) Appl. No.: 16/500,149

(22) PCT Filed: Apr. 2, 2018
(86) PCT No.: PCT/US2018/025708

§ 371 Date: Oct. 2, 2019

Related U.S. Application Data
(60) Provisional application No. 62/480,618, filed on Apr. 3, 2017.

(51) Int. Cl. H01J 49/16; H05H 1/34; G01N 27/623; H01J 27/26

(52) U.S. Cl. CPC H01J 49/168; H01J 27/26; G01N 27/623; H05H 1/34

(57) ABSTRACT

The present disclosure relates to systems and methods for ionizing a surface. In one implementation, an ionization source may include a microhollow cathode plasma or micro cavity plasma (MCP)-based ion source having a cavity and generating a plasma. A gas stream may pass through the cavity and transport the plasma. The source may further include one or more conductive electrodes located downstream from the MCP and configured to have a potential relative to the MCP such that positive and negative ions included in the plasma are carried through the electrodes by the gas stream. In another implementation, a mixer may mix a dopant (e.g. water) with the gas stream (e.g. air) entering the discharge. The disclosure also relates to a surface ionization probe.

### CROSS-REFERENCE TO RELATED APPLICATION

This application claims priority to U.S. Provisional Application No. 62/480,618, filed Apr. 3, 2017, the entire contents of which are incorporated herein.

### TECHNICAL FIELD

The present disclosure relates to a systems and methods for ionizing a surface. More specifically, and without limitation, the present disclosure relates to systems and methods for transferring ions along a transfer tube to a mass spectrometer.

### BACKGROUND

In mass spectrometry, a sample typically will be present on a solid surface, but may also be present as a vapor or aerosol. In most commercially available trace detection instruments for security applications, for example, for airport security applications, a surface is sampled by moving a swab over the surface to pick up the analyte, and subsequently by heating the swab. Analyte vapors coming off the swab may be ionized using an ion source, and the mass and/or mobility of the resulting ions may be determined and used for identification.

However, this method suffers from several drawbacks. For example, consumable swabs are needed, driving up costs and waste. In addition, the surface to be interrogated is usually touched by the operator, which may be hazardous if the analyte is poisonous or may be culturally inappropriate, for example, if the surface is part of a human being. Moreover, substances that do not form detectable vapors upon heating are not detectable using this technique.

Ambient ionization is a form of ionization in which ions are generally formed in an ion source outside the mass spectrometer without sample preparation or separation. Surface ionization is a form of ambient ionization where the sample is present on a solid surface. The combination of ambient ionization sources and miniature mass spectrometers has the possibility of allowing for non-contact detection of analytes of interest in the field. Of special interest for security applications are ion sources that may be used for the direct detection of contraband materials, such as drugs and explosives, off the surface of common items, such as laptops, shoes, and suitcases, which are typically targeted during a security inspection. Because these items usually must be returned intact to their rightful owners after analysis, it is usually preferred that the sampling process not change their surfaces. For at least this reason, the use of solvents or strong plasmas is generally avoided.

### BRIEF DESCRIPTION OF DRAWINGS

FIG. 1 is a diagram depicting an exemplary ion source, according to embodiments of the present disclosure.

FIG. 2A depicts an example of equipotential lines inside a microcavity plasma ion source when the plasma is ignited, according to embodiments of the present disclosure.

FIG. 2B depicts an example of plasma potential, electron energy, and ionization rate as a function of position along the line A-A′ of the example of FIG. 2A.

FIG. 2C depicts an example of the relationship between an MCP ion generating current and the voltage between the anode and cathode, according to embodiments of the present disclosure.

FIG. 3A is a diagram depicting an ion probe having a suboptimal offset distance.

FIG. 3B is a diagram depicting an ion probe having a more optimal offset distance, according to embodiments of the present disclosure.

FIG. 3C is a diagram depicting an ion probe having ion sources surrounding an inlet tube, according to embodiments of the present disclosure.

FIG. 4A shows an example of the downstream end of the example probe of FIG. 3B.

FIG. 4B shows an example of the downstream end of the example probe of FIG. 3B having a plurality of ion sources.

FIG. 5 shows an example of the exemplary ion source of FIG. 1 with a dopant delivery system, according to embodiments of the present disclosure.

FIG. 6A shows a cross section of the exemplary ion source of FIG. 1 with a grid having a positive potential, according to embodiments of the present disclosure.

FIG. 6B shows a cross section of the exemplary ion source of FIG. 1 with a grid having a negative potential, according to embodiments of the present disclosure.

FIG. 7 depicts an example of the average mass spectrum (below) and total ion count (top) of an ion source having a negative ion mode used in an example experiment in which water was added as a dopant to a gas stream before it entered an MCP.

FIG. 8 depicts an example of the mass spectrum from an example experiment using Pentaerythritol tetranitrate (PETN) deposited on a glass slide.

### SUMMARY

Embodiments of the present disclosure may solve problems with extant spectrometry. For example, embodiments of the present disclosure may allow for the use of mild plasmas as an alternative to damaging solvents and strong plasmas. Moreover, embodiments of the present disclosure may allow for highly energetic particles created in the plasma to be used without being brought into contact with the surface to be sampled.

In one example, a Low Temperature Plasma (LTP) ion source and inlet to a mass spectrometer were integrated into a single probe and connected to a mass spectrometer by a flexible transfer tube. However, the LTP ion source needs a 25 kHz, 2.5 kV AC voltage to create the ions. Embodiments of the present disclosure instead may use a microhollow cathode plasma (MCP) ion source that is driven by a 300V DC voltage. By using more than one source in parallel, embodiments of the present disclosure may use a mixture of reactant ions that cannot be achieved by a single ion source. MCP ion sources are generally easier to fabricate and operate in parallel than LTP ion sources such that a mixture of reactant ions may be created by operating each individual ion source at a different voltage. Parallelization further enables the creation of sources covering large surface areas with a high overall brightness (i.e., ion flux).

In one embodiment of the present disclosure, an ionization source may comprise a micro cavity plasma (MCP)-based ion source having a cavity and generating a plasma. A gas stream passing through the cavity may transport the plasma. The ionization source may further comprise one or more conductive electrodes located downstream from the MCP and configured to have a potential relative to the MCP such that positive and negative ions included in the plasma pass through the electrodes.

In some embodiments, at least one of the conductive electrodes may be further configured to absorb substantially all electrons from the plasma.

In any of the embodiments above, at least one of the conductive electrodes may comprise a grid that absorbs electrons but allows ions to pass.

In some embodiments, a first conductive electrode may be configured to repel electrons, and a second conductive electrode located upstream from the first electrode may be configured to absorb the repelled electrons.

In any of the embodiments above, the ion source may comprise two or more MCPs in parallel, the plasma voltages or currents in each cavity being controlled independently.

In another embodiment of the present disclosure, an ionization source may comprise a micro cavity plasma (MCP)-based ion source having a cavity and generating a plasma. A gas stream passing through the cavity may transport the plasma. The ionization source may further comprise a mixer configured to mix defined concentrations of a dopant with the gas stream entering the MCP.

In some embodiments, the dopant may be configured to stabilize the plasma.

In any of the embodiments above, the gas stream may comprise air. Additionally or alternatively, the dopant may comprise water. In such embodiments, the defined concentration may comprise air with a relative humidity between 20% and 40% at room temperature.

In any of the embodiments above, the mixer may be further configured to bubble the gas stream through a liquid containing the dopant before the gas stream enters the MCP.

In any of the embodiments above, the mixer may comprise a port located upstream from the MCP and configured to supply the dopant to the gas stream.

In another embodiment of the present disclosure, a method of ionizing a surface may comprise generating a plasma from a source fluid using a micro cavity plasma (MCP)-based ion source; transporting the plasma to the surface using a gas stream; transporting analyte ions generated by an interaction between the plasma and the surface to a detector using a gas stream; and analyzing the ions using the detector.

In some embodiments, transporting the plasma may further comprise removing electrons from the plasma using one or more conductive electrodes.

In any of the embodiments above, generating a plasma further comprises adding a dopant to the source fluid. In such embodiments, transporting the plasma further comprises adding a dopant to the plasma.

In another embodiment of the present disclosure, a surface ionization probe for use in probing a surface may comprise a first tube having an upstream end and a downstream end and an electrical discharge-based ion source having a discharge region and mounted part way down the first tube. The source may be configured to generate a plasma. A gas stream may pass through the discharge region and transport the plasma through the downstream end of the first tube to the surface. The probe may further comprise a second tube having two or more inlets. A gas flow may pass through the second tube and transport ions from the surface to a detector. The inlets of the second tube may form a ring-like structure around the first tube.

In some embodiments, the ion source may comprise an MCP-based ion source.

### DETAILED DESCRIPTION

One of the most important parts of any mass spectrometer system is the ion source, which is generally used to transform a sample into ions that can be analysed using the spectrometer. Surface ionization sources form a subset of ion sources that may be operated by pointing the ion source directly at a surface to be interrogated and transporting the resulting ions to the mass spectrometer. Surface ionization sources that use electric discharge in a flowing gas, broadly known as surface Atmospheric Pressure Chemical Ionization (s-APCI) sources, are particularly useful for fieldable mass spectrometers because no liquids or high pressure gases are needed for their operation. For example, air may be used as an ion source gas because it is readily available. Examples of APCI sources may include Plasma Assisted Desorption Ionization (PADI), Atmospheric Pressure Glow Discharge (APGD), and Dielectric Barrier Discharge (DBD)-based sources. These source may, for example, be based on a Low Temperature Plasma (LTP). Micro Cavity Plasma (MCP) ion sources, also known as micro hollow cathode ion sources, have received little attention as s-APCI sources. However, hollow cathode discharges have been used occasionally, and the physics of noble gas MCPs, especially Ar and He discharges, is well-understood.

Systems and methods of the present disclosure include an MCP-based ion source that uses flowing air as an ion source gas and may create a continuous stream of positive and negative ions to be used for surface ionization applications.

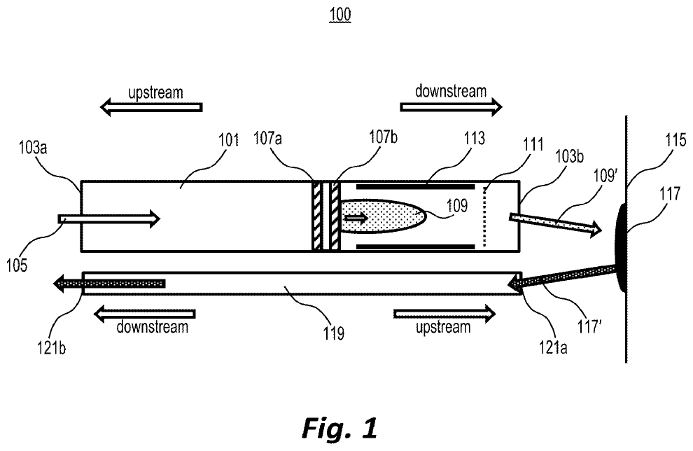

An example of an MCP-based probe 100 is shown schematically in FIG. 1. Probe 100 may comprise a tube-shaped structure 101 having an upstream end 103a and a downstream end 103b. Tube 101 may further include a connector (not shown) to upstream end 103a, where a gas flow 105 may enter tube 101. Probe 100 may further comprise an MCP-based ion source, mounted at least partway down the tube, which may comprise one or more microcavities formed, for example, by cathode 107a and anode 107b placed in parallel. The MCP-based ion source may generate an ion source plasma 109.

Probe 100 may further comprise a conductive electrode or mesh 111, positioned downstream from the MCP-based ion source, and may be brought to a range of potentials V1 relative to the second MCP plate (e.g., anode 107b) to remove electrons from the plasma such that a substantially neutral plasma 109′ remains. In some embodiments, a second downstream conductive electrode 113 may cover one or more portions of the wall of tube 101 and may be placed between the MCP-based ion source and the first downstream electrode 111. The second downstream electrode may be brought to a range of potentials V2 relative to the second MCP plate (e.g., anode 107b) to further facilitate removal of electrons from the plasma such that a substantially neutral plasma 109′ remains.

Neutral plasma 109′ may be dragged by the gas flow through downstream end 103b, leave probe 100, and move to a surface 115 to be interrogated for the presence of an analyte 117 present on the surface 115. Neutral plasma 109′ may convert analyte 117 to analyte ions 117′.

Probe 100 may further comprise a second tube 119 having a gas stream in the opposite direction to the first gas stream of first tube 101 such that analyte ions 117′ may be transported towards a mass spectrometer (not shown). The second tube 119 may have an upstream end 121a and a downstream end 121b. The upstream end 121a may have one or more inlets to transport analyte ions 117′ generated on the surface 115 towards a mass spectrometer (not shown) connected to downstream end 121b. The upstream end 121a of the second tube 119 may be aligned with the downstream end 103b of the first tube 101 such that the majority of the ions move from the first tube 101 to the second tube 119 after making contact with the surface 115 to be sampled.

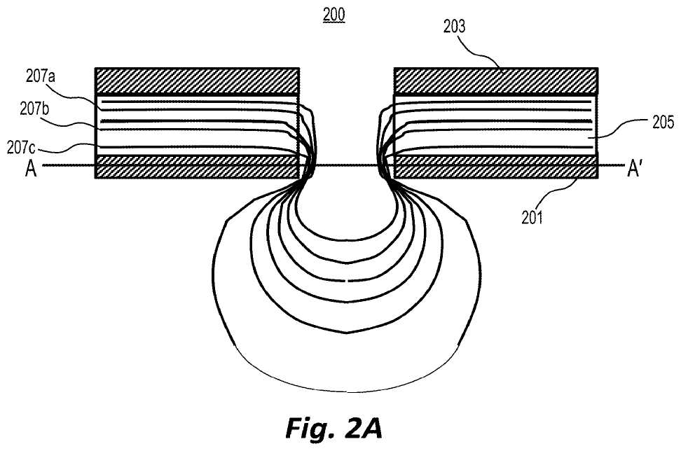

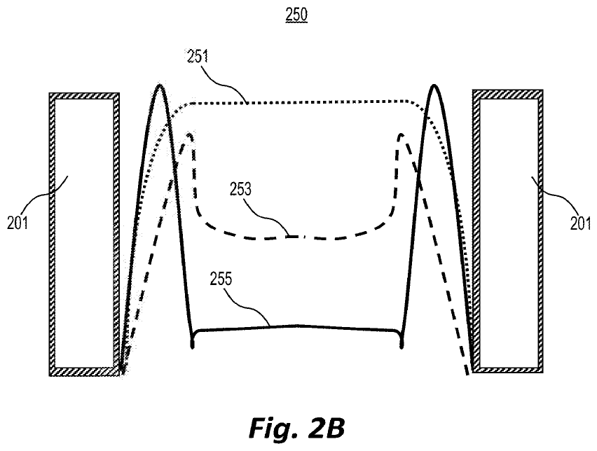

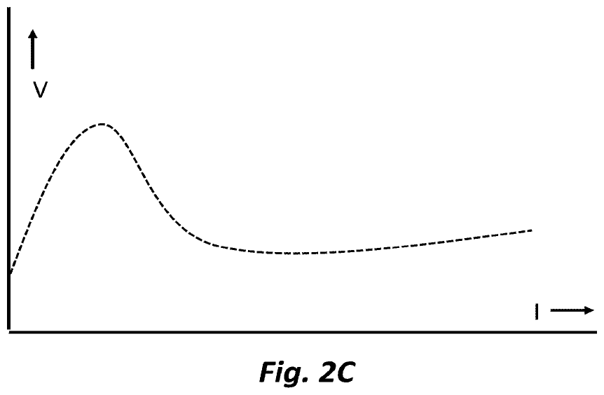

An example geometry 200 for an MCP-based ion source with a rotational symmetry along its central axis is shown in FIG. 2A. A potential difference of several hundreds of volts may be applied between anode 201 and cathode 203, which may be separated by a dielectric 205. Away from the microcavity, the resulting electric field points from the cathode 203 to the anode 201, as indicated by the equipotential lines on the left and right hand sides of FIG. 2A, e.g., lines 207a, 207b, and 207c. Above a certain threshold potential, an electric discharge may occur in the flowing gas and a conductive plasma comprising positive ions, negative ions, and electrons may be generated inside the microcavity.

FIG. 2B shows an example 250 of the plasma potential, the electron energy, and the ionization rate as a function of position along the line A-A′ of example 200 of FIG. 2A. The electric field inside the cavity may assume a shape as shown by the equipotential lines (e.g., lines 207a, 207b, and 207c) in the central cavity region of FIG. 2A, which may create high electric fields (as shown via closely spaced equipotential lines) close to a wall of anode 201 and negligible fields inside the bulk of plasma, as shown in FIG. 2B. As noted previously, all quantities in FIG. 2B are indicated along the line A-A′ in FIG. 2A, i.e., through the cavity hole in anode 201. Line 251 schematically represents the plasma potential inside the hole of anode 201. Line 251 shows that the plasma potential close to the walls of the hole is equal to the anode potential, but changes rapidly as one moves away from the wall to be very close to the cathode potential in the center of the cavity. Line 253 schematically represents the mean electron energy along line A-A′. Line 253 indicates that electrons that are generated at the cathode wall are accelerated towards the center of the hole. For small hole sizes, electrons can reach the other side of the hole before they lose much energy through collisions with neutral gas molecules. However, before they can reach the opposing wall they are accelerated back to the center of the hole by the opposing electric field. This causes electrons to oscillate back and forth through the plasma between the cathode walls. Each time an electron passes through the cavity it ionizes more neutral gas molecules, creating free electrons and ions in the process and intensifying the plasma. The ionization probability is indicated by line 255 in FIG. 2B. Accordingly, an intense plasma may be formed in an annulus around the center of the microcavity, with relatively few ions reaching the electrodes.

FIG. 2C shows an example of the plasma intensity as a function of electrode potential once the plasma has been ignited. For potentials over approximately 200V, the plasma is confined to the inside of the cavity and the plasma current increases slowly with an increase in potential. As the potential is increased further, the plasma may escape the cavity, and the Pendel effects begin to cause the plasma current to increase rapidly with an increase in potential. Upon a further increase, the Pendel effects become so strong that the potential needed drops as a function of current, and the plasma current becomes practically independent of the applied potential. In this region, an MCP-based ion source is best operated in controlled current mode. At very high currents, charged particles may begin to escape from the plasma to reach the electrode surfaces and surface ionization may begin to contribute to the plasma current. The impact of the charged particles on the electrode surface may increase electrode sputtering effects, thus reducing MCP life. Accordingly, the MCP-based ion source may be operated at as low a voltage as possible. If a higher plasma current is needed, for example, to create a more intense surface ionization source, several MCP-based ion sources may be used in parallel instead of increasing the operating voltage. To reduce sputtering effects, electrodes may be formed of refractory metals, such as molybdenum and tungsten. Additionally or alternatively, dielectric materials may include alumina and/or mica. Additionally or alternatively, oxide layers attached to the electrode surface(s) by thin layer deposition and/or oxidation of the electrode surface(s) may be used.

Ions may escape from the MCP-based ion source even when there is no gas flowing through the cavity, but they are generally ejected more efficiently when the gas in the cavity is moving downwards, as depicted in FIG. 2A.

Noble gas MCP-based ion sources generally have serious limitations when used with portable mass spectrometers. Apart from the fact that the noble gas would have to be carried on board the mass spectrometer system, noble gas discharges produce mainly positive ions (e.g., He⁺ and Ar⁺) and electrons. On the other hand, for many mass spectrometry applications, it is advantageous to create negative ions that react with the analyte of interest. These limitations may be overcome by using air as the discharge gas rather than a noble gas.

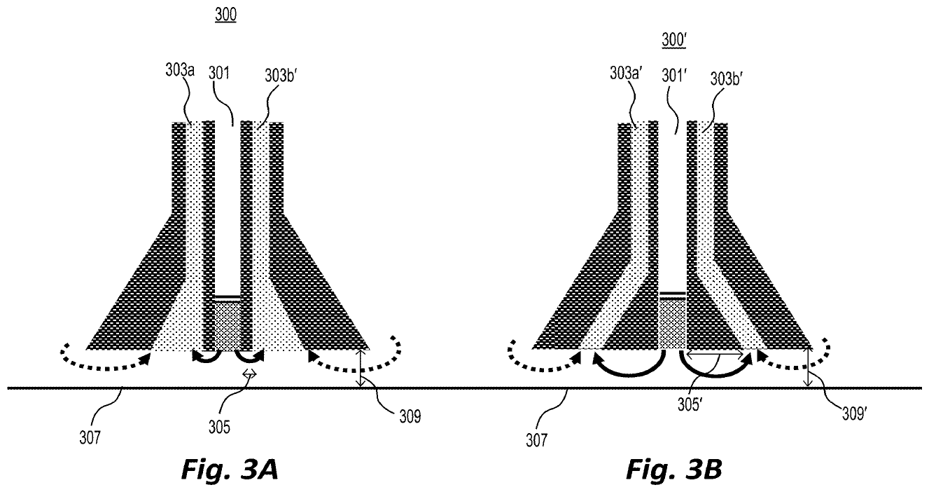

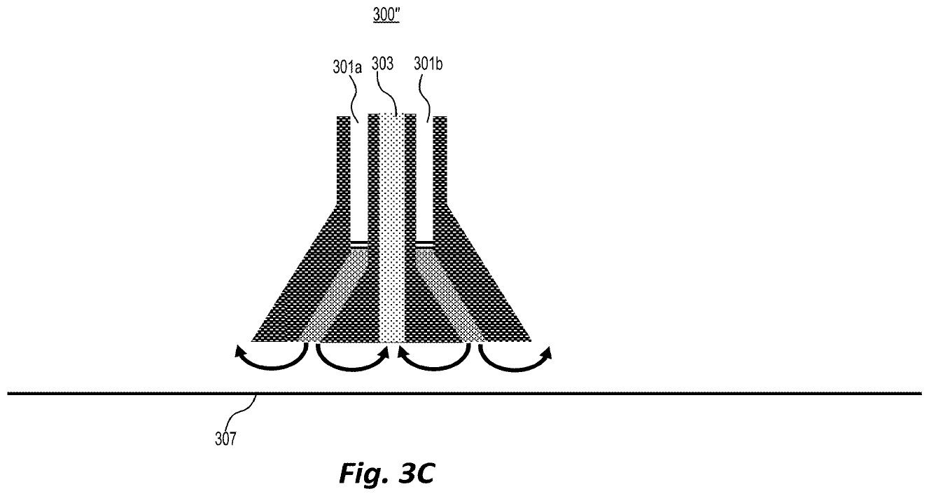

Once source ions have left the probe and react with the sample on the surface, analyte ions need to be transported into the mass spectrometer inlet so that they can be identified. In some embodiments, the ion source and inlet may be integrated into a single probe that can be moved along the surface of interest. A schematic for the combination of an ion source and inlet is shown in FIG. 1, described above. FIGS. 3A, 3B, and 3C show more detailed examples of the tip of such a probe.

As depicted in FIG. 3A, the ion source outlet 301 and the analyte ion inlets 303a and 303b may be placed at a distance 305. However, if distance 305 is much smaller than the distance between probe 300 and surface 307, ions generated by the MCP-based ion source will tend to move into the inlets 303a and 303b before they interact with the sample surface 307.

Accordingly, as depicted in FIG. 3B, distance 305′ between ion source outlet 301′ and analyte ion inlets 303a′ and 303b′ may be adjusted to be close to the distance 309′ between surface 307 and probe 300′. For example, distance 309′ may be within 5 mm and 1 cm of distance 305′.

FIGS. 3A and 3B both depict a plurality of analyte ion inlets surrounding an ion source outlet. Accordingly, ions leaving the outlet must pass in front of the inlets before escaping to the environment. Moreover, the inlet and outlet flows may be balanced such that there is only a small air flow from the environment into the inlet.

On the other hand, FIG. 3C depicts an alternative embodiment in which a central analyte ion inlet 303 is surrounded by a plurality of ion source outlets 301a and 301b. Accordingly, part of the ions leaving the outlets 301a and 301b in FIG. 3C will have a tendency to escape to the environment while another portion will engage with the surface 307 and reach the inlet 303. Therefore, probe 300″ of FIG. 3C may be more limited regarding the types and levels of ions, for example, ozone, that may safely be generated by the ion source and/or regarding the types of dopants that may be used safely. Accordingly, probe 300″ of FIG. 3C may minimize environmental air flow into inlet 303 and allow for parallel use of a plurality of MCP-based ion sources while requiring more environmentally safe ions and/or dopants.

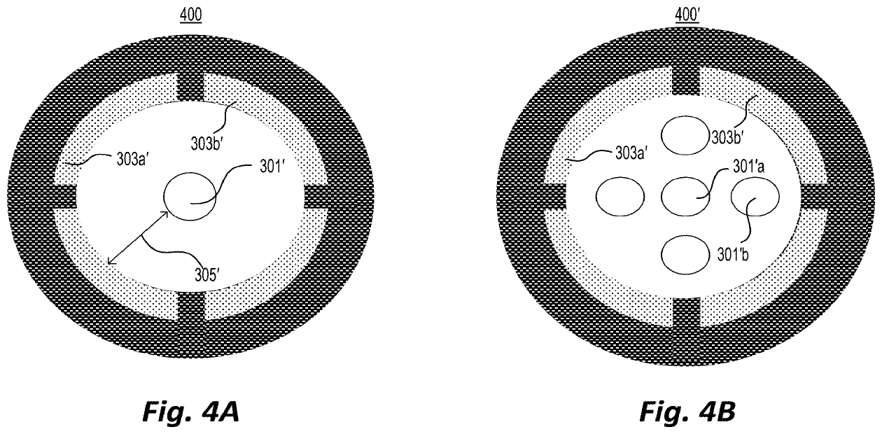

FIG. 4A shows a probe tip 400 for probe 300′ of FIG. 3B. As shown in FIG. 4A, ion source outlet 301′ may be centered or substantially centered on tip 400 and surrounded (e.g., in a ring-like fashion) by one or more analyte ion inlets, e.g., inlets 303a′ and 303b′.

FIG. 4B depicts an alternative embodiment in which a plurality of ion source outlets, e.g., outlets 301′a and 301′b, are surrounded (e.g., in a ring-like fashion) by one or more analyte ion inlets, e.g., inlets 303a′ and 303b′. Accordingly, probe tip 400′ may allow for parallel use of a plurality of MCP-based ion sources.

Creating a stable plasma in a microcavity is typically challenging, especially if the plasma is operated in air. Instabilities may become especially problematic if they cause the plasma to be completely extinguished. In order to reignite the plasma, extinction needs to be detected and a high voltage pulse has to be applied for reignition. Long-term plasma stability may be improved by modifying the plasma chemistry through dopants.

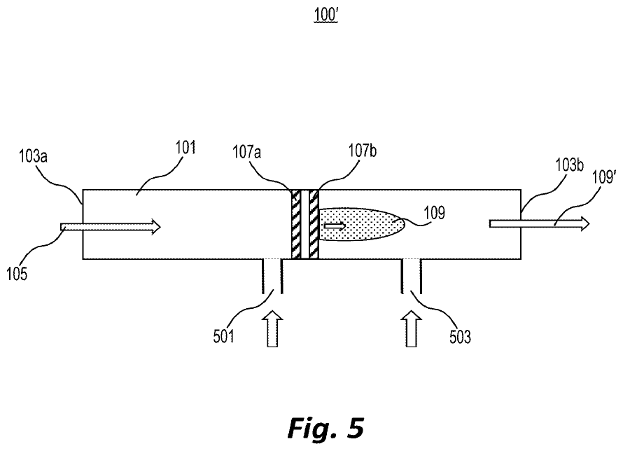

FIG. 5 shows a variation 100′ of probe 100 of FIG. 1, described above, that allows for dopants to be added to the ion source gas. In the example of FIG. 5, to modify the ion chemistry of the source, a dopant delivery system 501 may be placed upstream from the MCP-based ion source (e.g., represented by cathode 107a and anode 107b). If the delivery system 501 is placed a sufficient distance upstream, the dopant may mix with the air flowing through the probe and thus modify the ion chemistry.

Additional or alternative mixing geometries will be clear to those skilled in the art. For example, if the dopant is available in liquid form, the ion source gas may be mixed by bubbling through the dopant liquid. To modify the desorption chemistry of the solid sample from the surface, especially when using a dopant that may break down in the MCP-based ion source, a dopant delivery system 503 may be placed downstream from the MCP-based ion source.

Generally, special precaution is required when extracting negative ions from a plasma that comprises electrons as well as positive and negative ions, i.e., a plasma that is not a pure ion-ion plasma. The electrons tend to form a sheath around the plasma and create a positive plasma potential, as indicated by line 251 of FIG. 2B (described above). Although this potential tends to allow positive ions to escape, the negative ions are contained by the same potential.

A similar phenomenon may occur when a surface is placed in the plasma stream leaving the ion source, or when a potential is used to try and extract negative ions from a plasma. For example, one extant set-up used to extract ions from a plasma comprising electrons as well as positive and negative ions found that, as long as the plasma was ignited, positive ions could be extracted from it and detected by the mass spectrometer, while negative ions could not. Electrons could be extracted, but they were not detected by the mass spectrometer because of their very low mass. If the plasma was turned off, and the plasma electrons were given a few tens of milliseconds to leak away, both positive and negative ions could be extracted successfully for a period of a few hundreds of milliseconds, until the positive and negative ions recombined. The relative magnitudes of the positive and negative ion signals measured by the mass spectrometer indicated that the intensity for both ions was equal during this period.

Rather than separating the electrons and ions in time, as was done in the experiment described above, they may also be separated in space to create a continuously streaming ion-ion plasma. The mobility K of a charged particle may be described by example equation 1:

\vec{v_{D}(ι,e)}=K(i,e)*\vec{E} Equation 1

where \vec{v_{D} (ι, e)} is the drift velocity of the ion with respect to an electron in a stagnant gas, and \vec{E} is the electric field. The electron mobility K(e) depends somewhat on the electron energy and type of gas molecules, but is generally about 100× higher than typical ion mobilities K(i), as shown in example equation 2:

K(e)≈100K(i) Equation 2

It follows from equations 1 and 2 that, in the same electric field \vec{E}, the drift velocity of the electrons in the field may also be roughly 100× higher.

In a flowing gas at steady state, both ions and electrons travel at the speed of the gas \vec{v_{G}}. By combining the flow field and electric field effects, the equation of motion for charged particles is given by example equation 3:

\vec{v_{D}(ι,e)}=\vec{v_{G}}+K(i,e)\vec{E} Equation 3

Equation 3 indicates that, in a geometry with a given flow field the magnitude of the electric field \vec{E} may be chosen such that electron trajectories are far more dependent on the electric field than the flow field while ion trajectories remain determined by the flow field and experience little influence from the electric field. This result holds regardless of whether the flow and electric field vectors point in the same direction. Accordingly, in some embodiments, rather than turning the plasma off intermittently, electrons coming from the plasma may be separated from the ions using a combination of electric and flow fields, and the separated electrons may be absorbed using target electrodes having conductive surfaces. Below two examples applying these principles are given, but the disclosed systems and methods are not limited to those examples. Those skilled in the art will recognize other design equivalents using combinations of gas flow and electric fields that achieve the same objective of removing electrons from a flowing plasma.

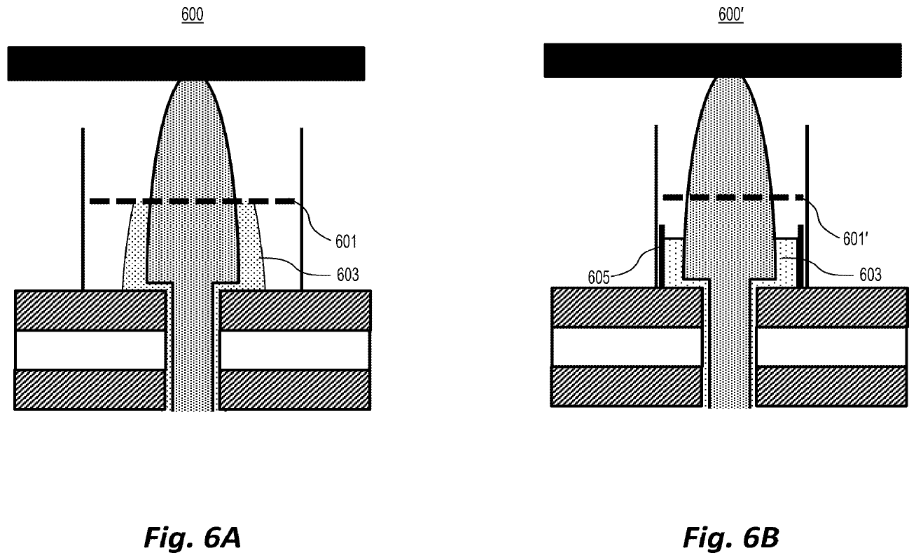

In one example 600, as depicted in FIG. 6A, a positive potential may be applied to a conductive grid electrode 601, which may be placed in the gas stream carrying the plasma. Electrons 603 are strongly attracted to the grid and tend to change their trajectories to collide with the grid, where they are absorbed. Negative ions are only weakly attracted by the grid, and most negative ions will be carried through the grid by the gas stream before they can collide with the grid. Positive ions are weakly rejected by the grid, but as long as the motion induced by the electric field remains smaller than the gas velocity, they will be carried through the grid as well.

In an alternative example 600′, as depicted in FIG. 5B, a negative potential is applied to a grid 601′ placed in the gas stream, which rejects or decelerating the electrons 603. In addition, a positive potential is applied to a ring-shaped electrode 605 placed concentrically around the plasma before the grid 601′. Ions are carried through the grid by the flowing gas while electrons 603 are repelled by the grid and attracted by the ring such that they move towards the ring where they are absorbed.

### Example

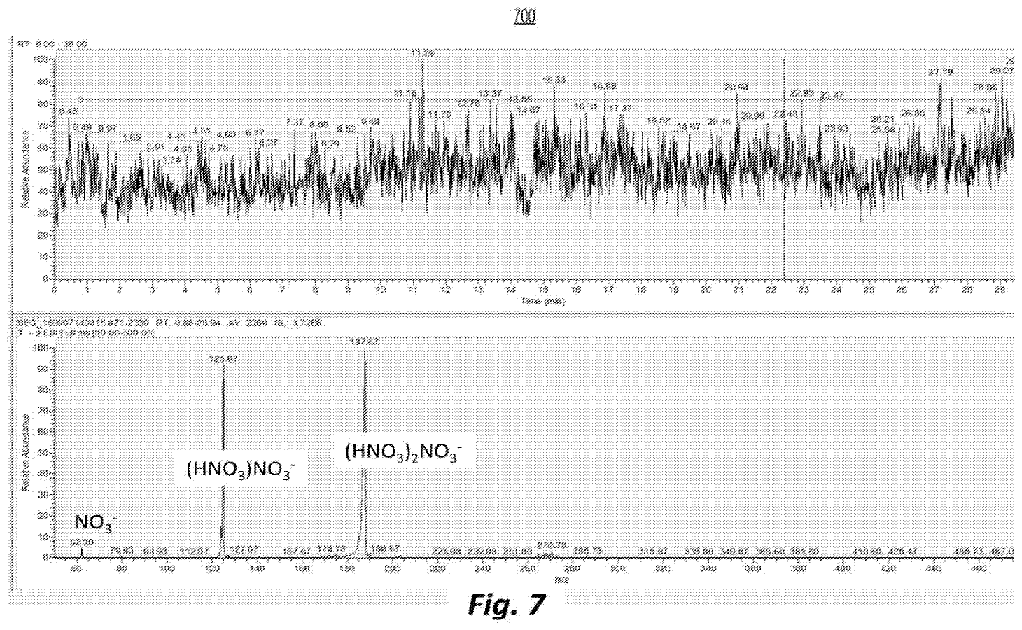

FIG. 7 shows the total ion count (top panel) and mass spectrum (bottom panel) for an MCP-based ion source pointing directly at the inlet of a Thermo Finnigan LCQ mass spectrometer. In control experiments using dried air as an ion source gas (not shown), the plasma was extinguished after a few tens of seconds for all combinations of gas flow rates and MCP voltages investigated, and a high voltage pulse was needed every time to reignite the plasma. By adding water vapor to the ion source gas upstream from the MCP-based ion source, a range of voltages and gas flows that produce a stable plasma may be found, as illustrated by the total number of ions counted by the mass spectrometer over a period of thirty minutes, shown in the top panel of FIG. 7. For example, a 470 mL/min. air flow with a relative humidity around 30% at room temperature produced a plasma that was stable over long periods, as indicated by the negative ions reaching the mass spectrometer without interruption. A small portion of the negative ions leaving the ion source are identified as NO₃⁻, but the majority consisted of (HNO₃) NO₃⁻ and (HNO₃)₂NO₃⁻ ions, as may be seen from the ion mass to charge ratios detected by the mass spectrometer, shown in the bottom panel of FIG. 7.

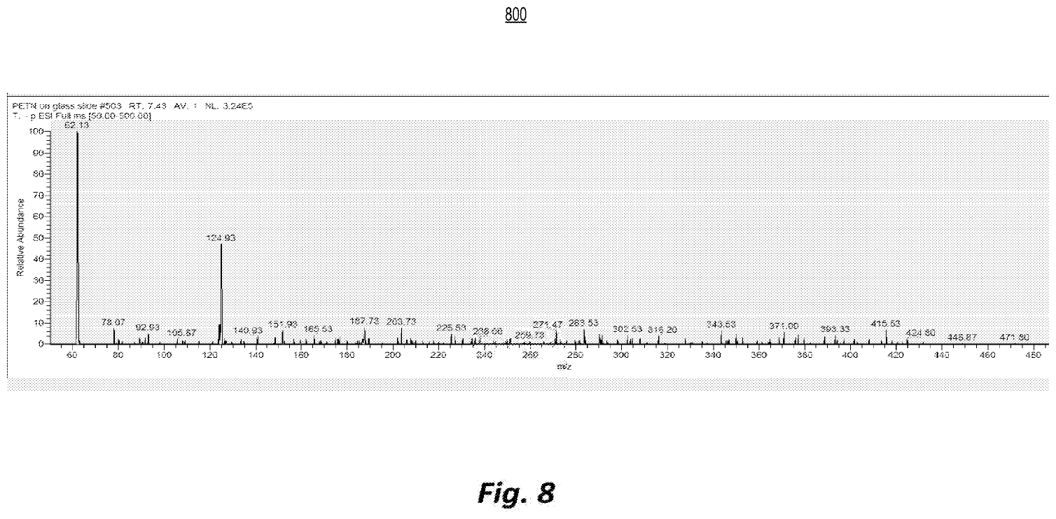

When the same probe was pointed at a glass surface, the detection of substances that form positive ions, like cocaine, was relatively straightforward, as depicted in the example of FIG. 8.

What is claimed is:

1. An ionization source, comprising:
a micro cavity plasma (MCP)-based ion source having a cavity and generating a plasma, wherein a gas stream passing through the cavity transports the plasma; and
one or more conductive electrodes located downstream from the MCP and configured to have a potential relative to the MCP such that positive and negative ions included in the plasma pass through the electrodes.

2. The ionization source of claim 1, wherein at least one of the conductive electrodes is further configured to absorb substantially all electrons from the plasma.

3. The ionization source of claim 2, wherein at least one of the conductive electrodes comprises a grid that absorbs electrons but allows ions to pass.

4. The ionization source of claim 2, wherein a first conductive electrode is configured to repel electrons, and a second conductive electrode located upstream from the first electrode is configured to absorb the repelled electrons.

5. The ionization source of claim 1, wherein the ion source comprises two or more MCPs in parallel, the plasma voltages or currents in each cavity being controlled independently.

6. An ionization source, comprising:
a micro cavity plasma (MCP)-based ion source having a cavity and generating a plasma, wherein a gas stream passing through the cavity transports the plasma; and
a mixer configured to mix defined concentrations of a dopant with the gas stream entering the MCP.

7. The ionization source of claim 6, wherein the dopant is configured to stabilize the plasma.

8. The ionization source of claim 6, wherein the gas stream comprises air.

9. The ionization source of claim 6, wherein the dopant comprises water.

10. The ionization source of claim 8, wherein the defined concentration comprises air with a relative humidity between 20% and 40% at room temperature.

11. The ionization source of claim 6, wherein the mixer is further configured to bubble the gas stream through a liquid containing the dopant before the gas stream enters the MCP.

12. The ionization source of claim 6, wherein the mixer comprises a port located upstream from the MCP and configured to supply the dopant to the gas stream.

13. A method of ionizing a surface, comprising:
generating a plasma from a source fluid using a micro cavity plasma (MCP)-based ion source;
transporting the plasma to the surface using a gas stream;
transporting analyte ions generated by an interaction between the plasma and the surface to a detector using a gas stream; and
analyzing the ions using the detector.

14. The method of claim 13, wherein transporting the plasma further comprises removing electrons from the plasma using one or more conductive electrodes.

15. The method of claim 13, wherein generating a plasma further comprises adding a dopant to the source fluid.

16. The method of claim 13, wherein transporting the plasma further comprises adding a dopant to the plasma.

17. A surface ionization probe for use in probing a surface, comprising:
a first tube having an upstream end and a downstream end;
an electrical discharge-based ion source having a discharge region and mounted part way down the first tube, wherein the source is configured to generate a plasma, and wherein a gas stream passes through the discharge region and transports the plasma through the downstream end of the first tube to the surface; and
a second tube having two or more inlets, wherein a gas flow passes through the second tube and transports ions from the surface to a detector,
the inlets of the second tube forming a ring-like structure around the first tube.

18. The surface ionization probe of claim 17, wherein the ion source comprises an MCP-based ion source.
